(19) United States
(12) Patent Application Publication
(10) Pub. No.: US 2024/0167965 A1
(43) Pub. Date: May 23, 2024

(54) INSPECTION ASSISTANCE SYSTEM, INSPECTION ASSISTANCE METHOD, AND PROGRAM

(71) Applicant: Panasonic Intellectual Property Management Co., Ltd., Osaka (JP)

(72) Inventors: Takanobu OJIMA, Osaka (JP); Daisuke KAJITA, Osaka (JP); Takeshi ARAI, Osaka (JP); Shota KOSAKA, Kyoto (JP); Kosuke MURAOKA, Osaka (JP)

(21) Appl. No.: 18/551,117

(22) PCT Filed: Mar. 10, 2022
(86) PCT No.: PCT/JP2022/010612

§ 371 Date: Sep. 18, 2023

(30) Foreign Application Priority Data
Mar. 22, 2021 (JP) 2021-047799

(51) Int. Cl. G01N 21/88; G06T 7/00; G06T 11/60; G06V 10/74; G06V 20/70

(52) U.S. Cl. CPC G01N 21/8851; G06T 7/001; G06T 11/60; G06V 10/761; G06V 20/70

(57) ABSTRACT

An inspection assistance system includes an image acquirer and an image creator. The image acquirer acquires a standard image about a target. The standard image is associated with a condition parameter set at a standard value. The condition parameter is set as a part of a process condition concerning a surface condition of the target. The image creator creates, by reference to the standard value, a plurality of evaluation images about the target by changing the condition parameter based on a predetermined image creation model and the standard image.

### TECHNICAL FIELD

The present disclosure generally relates to an inspection assistance system, an inspection assistance method, and a program, and more particularly relates to an inspection assistance system, an inspection assistance method, and a program concerning a surface condition of a target.

### BACKGROUND ART

Patent Literature 1 discloses inspection criteria determination apparatus. The inspection criteria determination apparatus determines, based on a psychometric curve, inspection criteria about an appearance feature quantity of a potentially defective region of a sample to see, based on the feature quantity (such as the size of a scratch or a crack and the degree of difference in color, for example), if that potentially defective region is actually defective. The inspection criteria determination apparatus includes an image presenting means, which presents a standard sample and a target sample to an inspector to make him or her compare the appearance feature quantities of respective potentially defective regions of the two samples and answer whether he or she finds the feature quantity of the target sample larger or smaller than that of the standard sample. The answer given by the inspector is acquired by an input means.

### CITATION LIST

### Patent Literature

Patent Literature 1: JP 2007-333709 A

### SUMMARY OF INVENTION

The inspection criteria determination apparatus of Patent Literature 1 needs to make, in advance, a design about the appearance feature quantities. Nevertheless, when the surface condition of a target is inspected, there may be a great many appearance feature quantities to check. For example, in the case of a surface coating layer, there may be multi-dimensional feature quantities if the color (lightness, saturation, and hue), gradation, the degree of granularity, the degree of glitter, the degree of gloss, and the degree of matte are all taken into account. That is why it is difficult to express, by a simple feature quantity, a sense of texture that an object gives to a human viewer. Also, even if the sense of texture could be expressed by a feature quantity, the subjective evaluation should go through a huge number of trials.

In view of the foregoing background, it is therefore an object of the present disclosure to provide an inspection assistance system, an inspection assistance method, and a program, all of which reduce the need for complicated designs.

An inspection assistance system according to an aspect of the present disclosure includes an image acquirer and an image creator. The image acquirer acquires a standard image about a target. The standard image is associated with a condition parameter set at a standard value. The condition parameter is set as a part of a process condition concerning a surface condition of the target. The image creator creates, by reference to the standard value, a plurality of evaluation images about the target by changing the condition parameter based on a predetermined image creation model and the standard image.

An inspection assistance method according to another aspect of the present disclosure includes image acquisition processing and image creation processing. The image acquisition processing includes acquiring a standard image about a target. The standard image is associated with a condition parameter set at a standard value. The condition parameter is set as a part of a process condition concerning a surface condition of the target. The image creation processing includes creating, by reference to the standard value, a plurality of evaluation images about the target by changing the condition parameter based on a predetermined image creation model and the standard image.

A program according to still another aspect of the present disclosure is designed to cause one or more processors to perform the inspection assistance method described above.

### BRIEF DESCRIPTION OF DRAWINGS

FIG. 1 is a block diagram illustrating a diagrammatic configuration for an inspection assistance system according to an exemplary embodiment:

FIG. 2 shows a concept of an overall system including the inspection assistance system:

FIG. 3A is a graph illustrating standard images and evaluation images in the inspection assistance system:

FIG. 3B is conceptual diagram showing how to display and evaluate the standard image and one of the evaluation images:

FIG. 4 is a graph showing how the inspection assistance system sets up inspection criteria:

FIG. 5 is a flowchart showing the procedure of a first exemplary operation of the inspection assistance system:

FIG. 6 is a flowchart showing the procedure of a second exemplary operation of the inspection assistance system:

FIG. 7 is a graph illustrating a first variation of the inspection assistance system:

FIG. 8 is a conceptual diagram illustrating a second variation of the inspection assistance system:

FIG. 9 is a graph illustrating a third variation of the inspection assistance system:

FIG. 10A is a graph illustrating standard images and evaluation images in an inspection assistance system according to a first one of other variations:

FIG. 10B is conceptual diagram showing how to display and evaluate the standard image and one of the evaluation images in the first one of the other variations;

FIG. 11 is a conceptual diagram illustrating a second one of the other variations (about a display mode) of the inspection assistance system; and

FIG. 12 is a conceptual diagram illustrating a third one of the other variations (about how to display inspection criteria process on a screen) of the inspection assistance system.

### DESCRIPTION OF EMBODIMENTS

### (1) Overview

The drawings to be referred to in the following description of embodiments are all schematic representations. Thus, the ratio of the dimensions (including thicknesses) of respective constituent elements illustrated on the drawings does not always reflect their actual dimensional ratio.

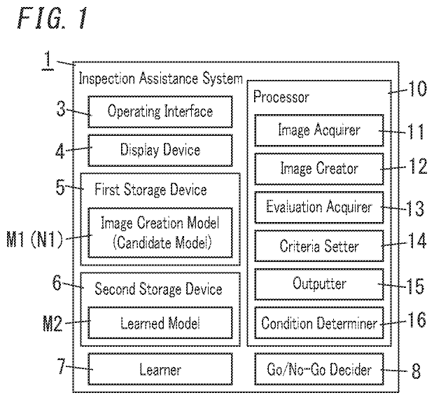

As shown in FIG. 1, an inspection assistance system 1 according to an exemplary embodiment includes an image acquirer 11 and an image creator 12.

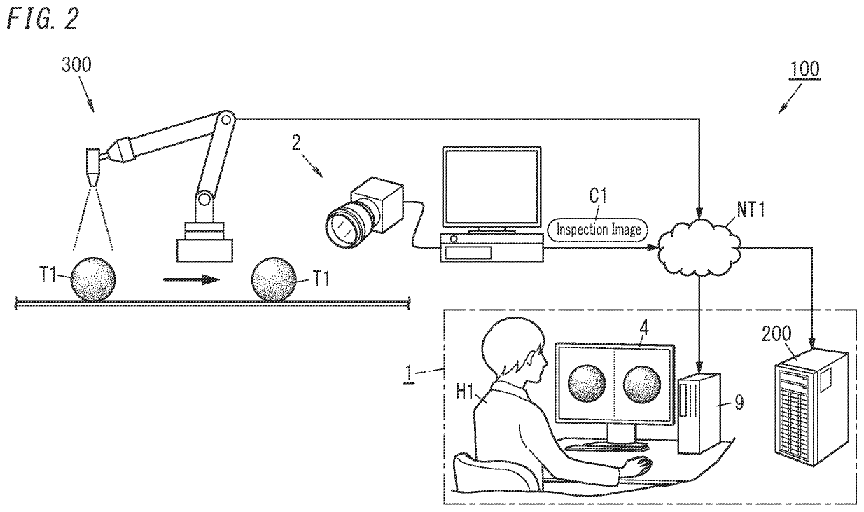

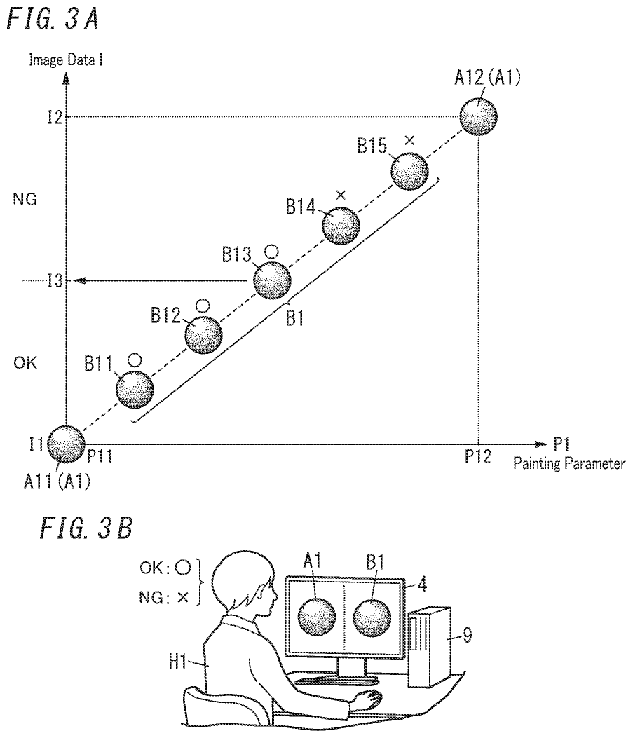

The image acquirer 11 acquires a standard image A1 (refer to FIGS. 3A and 3B) about a target T1 (refer to FIG. 2). The standard image A1 is associated with a condition parameter P1 (refer to FIG. 3A) set at a standard value. The condition parameter P1 is set as a part of a process condition concerning a surface condition of the target T1. In this embodiment, the target T1 is supposed to be an auto part, for example. However, the target T1 does not have to be auto part but only needs to be any object with a surface. Also, as used herein, the “surface condition” of the target T1 is supposed to be, for example, a condition of the surface coating layer. Therefore, the process condition is a painting condition. The condition parameter P1 is at least one parameter selected from the group consisting of: a discharge rate of a paint: an atomization pressure of the paint: a spraying distance to the surface of the target T1: the number of times of overcoating: and a drying rate of the paint. Alternatively, the “surface condition” may also be, for example, a condition of plating or a condition of decorative molding, not just the condition of the surface coating.

Note that in FIG. 2, only an area of the outer surface of an auto part (target T1) has its surface coating condition conceptually represented by a dotted hatched circle. That is to say, the circle does not indicate that the target T1 has a spherical shape. In the same way, in FIGS. 3A and 3B and other drawings, an image representing the surface coating condition of the target T1 is also conceptually represented by a dotted hatched circle.

The standard image A1 may be, for example, a captured image generated by making an image capture device 2 (refer to FIG. 2) shoot the target T1. That is to say, the standard image A1 may be a captured image representing a real product (sample product) of the target T1 which has been actually painted by a painting system 300 (refer to FIG. 2) with the condition parameter P1 set at a standard value. However, the standard image A1 does not have to be a captured image of a real object but may also be a pseudo-image (CG image) created by setting the condition parameter P1 at a standard value. The standard image A1 may be, but does not have to be, a single still picture. Alternatively, the standard image A1 may also be a moving picture.

The image creator 12 creates, by reference to the standard value, a plurality of evaluation images B1 (refer to FIG. 3) about the target T1 by changing the condition parameter P1 based on a predetermined image creation model M1 and the standard image A1. In this embodiment, the image creation model M1 may be, for example, a function model that uses the condition parameter P1 as a variable. Each of the evaluation images B1 is an image that has been created, based on the standard image A1, by controlling the color densities (pixel values) of the three primary colors of an RGB color space. However, the color space does not have to be the RGB color space but may also be an XYZ color space or a Lab (Lab color space).

According to this configuration, a plurality of evaluation images B1 are created by using a condition parameter P1 which is set as a part of a process condition. Thus, using the evaluation images B1 makes it easier to set up inspection criteria than making a design about complicated appearance feature quantities, for example. Consequently, this inspection assistance system 1 achieves the advantage of reducing the need for complicated design.

An inspection assistance method according to this embodiment includes image acquisition processing (image acquisition step) and image creation processing (image creation step). The image acquisition processing (image acquisition step) includes acquiring a standard image A1 about a target T1. The standard image A1 is associated with a condition parameter P1 set at a standard value. The condition parameter P1 is set as a part of a process condition concerning a surface condition of the target T1. The image creation processing (image creation step) includes creating, by reference to the standard value, a plurality of evaluation images B1 about the target T1 by changing the condition parameter P1 based on a predetermined image creation model M1 and the standard image A1. This provides an inspection assistance method that reduces the need for complicated design. This inspection assistance method is used on a computer system (inspection assistance system 1). That is to say, this inspection assistance method may also be implemented as a program. A program according to this embodiment is designed to cause one or more processors to perform the inspection assistance method according to this embodiment.

### (2) Details

An overall system (painting management system 100) including the inspection assistance system 1 according to this embodiment and peripheral constituent elements thereof will be described in detail with reference to FIGS. 1 and 2. Note that at least some of the peripheral constituent elements may be included in the inspection assistance system 1.

### (2.1) Overall Configuration

As shown in FIG. 2, the painting management system 100 includes the inspection assistance system 1, the painting system 300, and an image capture device 2 (image capturing system).

The inspection assistance system 1 has the capability of assisting a person in making, as inspection criteria, a so-called “boundary sample” indicating a limit in the quality of a painted product. That is to say, a product, of which the quality is equal to or higher than the limit, is determined to be a non-defective product (OK, which means a GO). On the other hand, a product, of which the quality is lower than the limit, is determined to be a defective product (NG (no good), which means a NO-GO). Specifically, for example, an auto part manufacturer makes a boundary sample (sample product) about a painted product of a certain part and shares information about the boundary sample with customers of auto manufacturers and other people to reach an agreement in manufacturing the painted product. In addition, letting the inspector check the boundary sample while the painted product that has gone through the painting process during an actual operation of a production line is being inspected allows the inspection process to be carried out with good stability and accuracy. Nevertheless, it may take a huge cost and time to make such a boundary sample. That is why this inspection assistance system 1 is configured to assist a person in making such a boundary sample.

In the following description, the work of making a boundary sample will be hereinafter referred to as “sample making work” and a person who carries out this work will be hereinafter referred to as a “maker H1” (refer to FIGS. 2 and 3B) for the sake of convenience of description. Also, the work of inspecting a painted product on an actual production line will be hereinafter referred to as “inspection work” and a person who carries out this inspection work will be hereinafter referred to as an “inspector.” Note that if there is no need to distinguish the maker H1 and the inspector in description, then the maker H1 and the inspector will be hereinafter collectively referred to as “users.” In some cases, the maker H1 and the inspector may be the same person.

In this embodiment, the inspection assistance system 1 includes a processor 10, an operating interface 3, a display device 4, a first storage device 5, a second storage device 6, a learner 7, and a go/no-go decider 8 (inferrer) as shown in FIG. 1. The main functions of the inspection assistance system 1 (the functions of the processor 10, the first storage device 5, the second storage device 6, the learner 7, and the go/no-go decider 8) are supposed to be provided for a server 200 (refer to FIG. 2), for example. The server as used herein is supposed to be a single server device. That is to say, the main functions of the inspection assistance system 1 are supposed to be provided for the single server device. However, this is only an example and should not be construed as limiting. Alternatively, the “server” may also be made up of a plurality of server devices. Specifically, the respective functions of the processor 10, the first storage device 5, the second storage device 6, the learner 7, and the go/no-go decider 8 may be provided for five different servers. Alternatively, the functions of two or more of these constituent elements may be provided for a single server device. Optionally, those server devices may form a cloud computing system. Also, some functions oof the inspection assistance system 1 may be distributed in not only the server(s) but also a (desktop) personal computer, a laptop computer, or a tablet computer, for example. The server device(s) may be installed in either a factory where at least one of the painting process or the painting inspection is carried out or outside of the factory (e.g., at the headquarters). If the respective functions of the inspection assistance system 1 are provided for multiple server devices, each of those server devices is preferably connected to the other server devices to be ready to communicate with the other server devices.

The image capture device 2 (image capturing system) is a system for generating an image (digital image) representing the surface of the target T1. In this embodiment, the image capture device 2 generates an image representing the surface of the target T1 by, for example, shooting the surface of the target T1 being lighted up by lighting equipment. The image capture device 2 may include, for example, one or more RGB cameras. Each camera includes one or more image sensors. Alternatively, each camera may include one or more line sensors. The image capture device 2 is connected to a network NT1 as shown in FIG. 2 and may communicate with the server 200 via the network NT1. The network NT1 is not limited to any particular one. The network NT1 may be established by either wired communication via a communications line or wireless communication, whichever is appropriate. Examples of the wired communication include communications via a twisted pair cable, a dedicated communications line, or a local area network (LAN) cable. Examples of the wireless communications include wireless communications compliant with the Wi-Fi(R) standard, the Bluetooth(R) standard, the ZigBee(R) standard, or a low power radio standard requiring no licenses (Specified Low Power Radio standard) and a wireless communication such as an infrared communication.

In this embodiment, the same image capture device 2 is used in both the “sample making work” and “inspection work.” However, this is only an example and should not be construed as limiting. Alternatively, two different image capture devices may be used in these two types of work.

The painting system 300 is a system for painting the surface of the target T1. That is to say, the painting system 300 performs a painting process on the target T1. The painting system 300 includes one or more painting devices (painting robots). The painting robot may have a structure well known in the art, and detailed description thereof will be omitted herein. The painting system 300 is connected to the network NT1 as shown in FIG. 2 and may communicate with the server 200 via the network NT1. The communication between the painting system 300 and the server 200 is not limited to any particular one. As in the communication between the image capture device 2 and the server 200, the communication may be established by either wired communication via a communications line or wireless communication, whichever is appropriate.

In this embodiment, the same painting system 300 is used in both the “sample making work” and “inspection work.” However, this is only an example and should not be construed as limiting. Alternatively, two different painting systems may be used in these two types of work, respectively.

### (2.2) Configuration for Inspection Assistance System

Next, respective constituent elements (namely, the processor 10, the operating interface 3, the display device 4, the first storage device 5, the second storage device 6, the learner 7, and the go/no-go decider 8) of the inspection assistance system 1 will be described in further detail.

The processor 10 is implemented as a computer system including one or more processors (microprocessors) and one or more memories. That is to say, the computer system performs the functions of the processor 10 by making the one or more processors execute one or more programs (applications) stored in the one or more memories. In this embodiment, the program(s) is/are stored in advance in the memory/memories of the processor 10. However, this is only an example and should not be construed as limiting. The program(s) may also be downloaded via a telecommunications line such as the Internet or distributed after having been stored in a non-transitory storage medium such as a memory card.

The processor 10 performs processing involving the image capture device 2 and the painting system 300. The functions of the processor 10 are supposed to be provided for the server 200. Also, as shown in FIG. 1, the processor 10 includes an image acquirer 11, an image creator 12, an evaluation acquirer 13, a criteria setter 14, an outputter 15, and a condition determiner 16. That is to say, the processor 10 has respective functions as the image acquirer 11, the image creator 12, the evaluation acquirer 13, the criteria setter 14, the outputter 15, and the condition determiner 16.

The image acquirer 11 is configured to acquire a standard image A1 about the target T1. The standard image A1 is a captured image generated by making the image capture device 2 shoot the target T1. That is to say, the standard image A1 is a captured image of the target T1 as a real product which has been actually painted by the painting system 300 as a preparatory step for the sample making work with the condition parameter P1 set at a standard value. In performing the sample making work, the inspection assistance system 1 receives information about the standard image A1 from the image capture device 2.

In this example, the condition parameter P1 is set to control the condition for painting the target T1. The condition parameter P1 is at least one parameter selected from the group consisting of: a discharge rate of a paint: a pressure at which the paint is atomized (i.e., atomization pressure): a spraying distance to the surface of the target T1: the number of times of overcoating: and a drying rate of the paint.

The painting system 300 performs the painting process including overcoating the target T1 (such as the surface of a vehicle body) over multiple layers while changing at least one of the color or type of the paint with the discharge rate, the atomization pressure, the spraying distance, the number of times of overcoating, and other parameters adjusted. As used herein, the discharge rate refers to a rate (L/min) at which the paint is discharged from a spray gun at the tip of the painting robot, for example. The atomization pressure herein refers to the pressure of the paint that has been atomized by supplying the air that has been pressurized by an air compressor to the spray gun. The spraying distance herein refers to the distance from the spray gun to the target T1, for example.

The multiple layers may include, for example, an anticorrosive electrodeposited coating layer (first layer), a first base coating layer (second layer), a second base coating layer (third layer), and a clear coating layer (fourth layer), which are laid one on top of another in this order on the surface of the target T1. The thickness of each coating layer may be controlled by adjusting the discharge rate, the spraying distance, and the number of times of overcoating. If the second or third layer is thin, then the underlying material will be seen more easily through the overcoating layers. On the other hand, if the fourth layer is thin, then the overcoat will look glossier. Providing the second to fourth layers with the thicknesses of the coating layers controlled in this manner contributes to improving the coloring, the aesthetic appearance, the gloss, and other properties of the overcoat. The atomization pressure affects the granulation (i.e., degree of granularity) of the overcoat. The granulation of the overcoat (the degree of granularity) affects a unique surface finish such as a granular surface finish. The drying rate affects the degree of uniformity in the orientation of aluminum flakes, which are flakes of an aluminum powder, to impress the viewer more deeply with the metallic appearance of the overcoat.

In the following description, attention is paid to the discharge rate (L/min) of the paint and the condition parameter P1 (painting parameter) is supposed to be a parameter about the discharge rate, for example. If there are ten setting levels (Level 1 through Level 10) indicating the discharge rates that may be set with respect to one layer (e.g., the third layer) out of the multiple layers, then the standard value is a value of the condition parameter P1 corresponding to a discharge rate at the middle standard Level 5. Such a value of the condition parameter P1 corresponding to the discharge rate at the standard level will be hereinafter referred to as a “first standard value P11” (refer to FIG. 3A). FIG. 3A is a graph, of which the abscissa indicates the condition parameter P1 (painting parameter p), and the ordinate indicates the image data I (e.g., the color density (pixel value) about RGB).

The image creator 12 is configured to create a plurality of (e.g., five in the example shown in FIG. 3A) evaluation images B1. These five evaluation images B1 are created by changing, by reference to the standard value, the condition parameter P1 at regular intervals based on the image creation model M1 and the standard image A1. In this case, the image acquirer 11 further acquires a standard image A1 in which the condition parameter P1 is set at a second standard value P12, which is different from a first standard value P11 as the standard value. The image creator 12 creates a plurality of evaluation images B1 by changing the condition parameter P1 between the first standard value P11 and the second standard value P12. In FIG. 3A, the second standard value P12 may be, for example, a value of the condition parameter P1 corresponding to a discharge rate at the highest Level 10 among the ten levels of the discharge rate that can be set. The second standard value P12 is not limited to any particular degree as long as the second standard value P12 is different from the first standard value P11. In any case, the second standard value P12 is preferably significantly different from the first standard value P11. In particular, in this embodiment, a limit indicating whether the sample is a GO (OK) or a NO-GO (NG) needs to be set as the inspection criteria. That is why the first standard value P11 is preferably a value at which the sample may be easily determined to be a GO (OK) even to the naked eye, and the second standard value P12 is preferably a value at which the sample may be easily determined to be a NO-GO (NG) even to the naked eye.

In FIG. 3A, image data I1 located at the origin is captured image data of the real product (sample product) of the target T1 that has been actually painted by the painting system 300 at the first standard value P11 (discharge rate) under a first painting condition (hereinafter referred to as a “first standard image A11”). On the other hand, in FIG. 3A, image data 12 is captured image data of the real product (sample product) of the target T1 that has been actually painted by the painting system 300 at the second standard value P12 (discharge rate) under a second painting condition (hereinafter referred to as a “second standard image A12”).

The image creation model M1 is a function model that uses the condition parameter P1 as a variable. In this case, supposing a painting parameter as the condition parameter P1 is p (variable), the image data I (color density) of the evaluation image B1 is determined by a function f(p) (image creation model M1). That is to say, the function f(p) (approximately) defines the characteristic of a variation in RGB color density with respect to the discharge rate (condition parameter P1) for one layer (e.g., the third layer). The function f(p) is obtained by either verification by measurement or simulation, for example. Information about the image creation model M1 is stored in advance in the first storage device 5.

To make the following description easily understandable, the evaluation images B1 are supposed to be created with only the discharge rate (condition parameter P1) for the third layer changed as a condition parameter P1 of interest and with the condition parameters P1 for the other layers, such as discharge rates, the number of times of overcoating, and the atomization pressure, fixed at standard values, as far as the painting condition is concerned. However, this is only an example and should not be construed as limiting. Alternatively, the evaluation images B1 may also be created with two or more condition parameters P1 changed in parallel. For example, if the discharge rate and the number of times of overcoating are changed in parallel, then a function f(p) defining the characteristic of a variation in color density with respect to the discharge rate and the number of times of overcoating may be prepared for the image data I (color density) of the evaluation images B1.

The first storage device 5 and the second storage device 6 may each include a rewritable nonvolatile memory such as an electrically erasable programmable read-only memory (EEPROM).

The first storage device 5 stores information about various painting conditions. In addition, the first storage device 5 also stores multiple image creation models M1. That is to say, the first storage device 5 stores not only the function f(p) of the discharge rate for the third layer but also the functions f(p) of the discharge rates for the first, second, and fourth layers and many other functions f(p) of the atomization pressure, the spraying distance, the number of times of overcoating, and the drying rate. The second storage device 6 stores the learned model M2 (to be described later). In this embodiment, the first storage device 5 and the second storage device 6 are supposed to be two different storage devices. However, the first storage device 5 and the second storage device 6 may be a single common storage device. Also, at least one of the first storage device 5 or the second storage device 6 may be a memory of the processor 10.

Also, the image data I (color density) of the evaluation image B1 may be calculated simply by the following Equation (1) (image creation model M1):

I=ΔI×α+I1 (1)

In Equation (1), ΔI is a difference obtained by subtracting the image data I1 (color density) of the first standard image A11 from the image data 12 (color density) of the second standard image A12 and α is a value obtained by normalizing the painting parameter p and may fall within the range from 0 to 1. That is to say, the painting parameters p including the discharge rate, the number of times of overcoating, and the atomization pressure have respectively different units, and therefore, α scales possible values for a pair of standard images (i.e., from the first standard image A11 through the second standard image A12) to the range from 0 through 1 with respect to the discharge rate the number of times of overcoating, the atomization pressure, and other parameters.

When Equation (1) is adopted, the image creator 12 determines the respective RGB color densities (pixel values) of the first standard image A11 and the second standard image A12 to calculate the difference ΔI. The image creator 12 changes α, multiplies α by the difference ΔI every time α is changed, and adds the product to the image data I1 (color density) of the first standard image A11 that forms the basis, thereby creating a plurality of evaluation images B1 with respect to the target T1. FIG. 3A shows five evaluation images B1 created simply by Equation (1). Therefore, the respective color densities of the five evaluation images B1 increase progressively and linearly (proportionally) as the painting parameter p increases.

The evaluation acquirer 13 is configured to acquire evaluation information about the results of evaluations that have been made in two or more stages on the plurality of (e.g., five in this example) evaluation images B1. In this example, the results of evaluations are supposed to have two stages, namely, GO (OK) and NO-GO (NG). Each result of evaluation is subjective evaluation made by the maker H1. Specifically, the maker H1 evaluates each evaluation image B1 with the naked eye and enters the result of evaluation (which is either OK or NG) with respect to each evaluation image B1 using the operating interface 3 as shown in FIG. 3B.

The display device 4 is implemented as a liquid crystal display or an organic electroluminescent (EL) display. Alternatively, the display device 4 may also be a touchscreen panel display. The display device 4 may be provided as an annex for a telecommunications device 9 (refer to FIG. 3B) such as a desktop personal computer used by the user. The telecommunications device 9 may also be a laptop computer or a tablet computer, for example. The display device 4 displays the standard image A1 and the plurality of evaluation images B1 thereon.

The server 200 and the telecommunications device 9 may communicate with each other via the network NT1. In performing the sample making work, the telecommunications device 9 receives, from the server 200, information about the standard image A1 and the evaluation images B1 and displays the information on the monitor screen of the display device 4. This allows the maker H1 to make a visual check of the standard image A1 and the evaluation images B1 on the display device 4. In particular, in this embodiment, the standard image A1 and each evaluation image B1 are displayed simultaneously on the same screen as shown in FIG. 3B to make it easier for the maker H1 to compare the standard image A1 and each evaluation image B1 with the naked eye. The display device 4 displays not only the standard image A1 and the evaluation images B1 but also various other types of information as well.

The operating interface 3 includes a mouse, a keyboard, a pointing device, and other input devices. The operating interface 3 is provided, for example, for the telecommunications device 9 to be used by the user. If the display device 4 is a touchscreen panel display, the display device 4 may also perform the function of the operating interface 3. The maker H1 compares, with the eye, the standard image A1 and each evaluation image B1, which are displayed on the display device 4, evaluates the evaluation image B1 to be either GO (OK) or NO-GO (NG), and enters the result of evaluation into the inspection assistance system 1 via the operating interface 3. The processor 10 stores, in association with each other, the result of evaluation thus entered and the evaluation image B1 in the storage device (such as the first storage device 5).

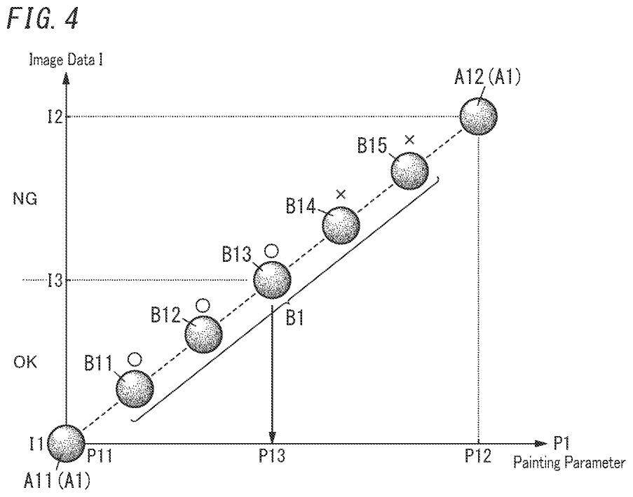

The criteria setter 14 is configured to set up, based on the evaluation information, inspection criteria concerning the surface condition of the target T1. In FIGS. 3A and 4, shown are results of evaluations made by the maker H1 who evaluated evaluation images B11-B13 to be OK and evaluation images B14, B15 to be NG out of the five evaluation images B1 (B11-B15). On the drawings, an open circle mark is placed beside each of the evaluation images B11-B13 evaluated to be OK, and a cross mark is placed beside each of the evaluation images B14, B15 evaluated to be NG.

The criteria setter 14 locates a boundary where the results of evaluations with respect to the plurality of evaluation images B1 that are arranged in line change from OK into NG. Specifically, the criteria setter 14 sets the inspection criteria at an evaluation image B1, of which the result of evaluation is OK but is closest to NG (i.e., the evaluation image B13 in the example shown in FIG. 4). The processor 10 stores, in the storage device (such as the first storage device 5), information about the image data 13 (color density) and inspection criteria value P13 (third painting condition) of the evaluation image B13 that has turned out to be the inspection criteria.

The outputter 15 is configured to output information about the condition parameter P1 associated with the inspection criteria (i.e., the inspection criteria value P13 in FIG. 4). That is to say, the outputter 15 outputs information about the third painting condition to an external device (such as the telecommunications device 9). In other words, the server 200 transmits information about the third painting condition to the telecommunications device 9. In response, the telecommunications device 9 makes the display device 4 present the information about the third painting condition. The information about the third painting condition includes not only the inspection criteria value P13 with respect to the discharge rate of one layer subjected to change but also condition parameters P1 such as the discharge rates of the other layers, the number of times of overcoating, and the atomization pressure which are fixed at the standard value.

The maker H1 makes, in accordance with the third painting condition presented, a target T1 to be a boundary sample. That is to say, the maker H1 enters, via a user interface, information about the third painting condition presented to the painting system 300. As a result, the painting system 300 performs painting in accordance with the third painting condition to make the target T1 (as a boundary sample). The boundary sample thus made comes to have a painting condition which is very close to that of the evaluation image B13 created by the image creator 12.

The outputter 15 may output the information about the third painting condition directly to the painting system 300, not to the telecommunications device 9. In that case, the painting system 300 may perform painting in accordance with the third painting condition that has been received directly from the server 200 to make the target T1 (boundary sample).

Feeding back the information thus output about the third painting condition to the painting process in this manner allows the maker H1 to make and check a real product (boundary sample) that meets the inspection criteria.

In this embodiment, the first storage device 5 stores a plurality of candidate models N1 (refer to FIG. 1) respectively associated with a plurality of standard values of the condition parameter P1. The plurality of candidate models N1 as used herein may include a plurality of image creation models M1 which have once been applied to setting up the inspection criteria in the past, for example.

The condition determiner 16 determines the degree of similarity between the standard value and each of a plurality of standard values and selects, when the plurality of standard values includes any particular value having a high degree of similarity with the standard value, a candidate model N1, associated with the particular value and belonging to the plurality of candidate models N1, as the predetermined image creation model M1. To be more specific, the condition determiner 16 compares, with a threshold value, the absolute value (Ip−p′l) of the difference between a first standard value P11 (painting parameter p) of a discharge rate of interest and each of a plurality of first standard values P11 (painting parameters p′) associated with a plurality of candidate models N1. When finding any candidate model N1, of which the absolute value (|p−p′|) is less than the threshold value, in the first storage device 5, the condition determiner 16 selects the candidate model N1 as the image creation model M1.

This condition determination processing is preferably performed by the condition determiner 16 as a preparatory step for the sample making work. When finding no candidate models N1, of which the absolute value (|p−p′|) is less than the threshold value, in the first storage device 5, the server 200 notifies the telecommunications device 9 to that effect. In that case, the maker H1 makes a new image creation model M1 and enters its information into the inspection assistance system 1 via the operating interface 3.

As can be seen from the foregoing description, the condition determiner 16 determines the degree of similarity and selects the image creation model M1. This saves the maker H1 the trouble of newly making or selecting the image creation model M1. Consequently, the inspection criteria may be set up more efficiently.

The learner 7 generates a learned model M2 (refer to FIG. 1) by using, as learning data, image data, to which a label is attached. The label indicates whether the surface condition (painting condition in this case) is good or bad and meets the inspection criteria set up by the criteria setter 14.

As used herein, the “learning data” is used to make machine learning about a model. The “model” is a program which estimates, upon receiving input data about a target to recognize (i.e., the surface condition of the target T1), the condition of the target to recognize and outputs a result of estimation (i.e., result of recognition). Also, as used herein, the “learned model” refers to a model about which machine learning using the learning data is completed. Furthermore, the “learning data (set)” refers to a data set including, in combination, input data (image data) to be entered for a model and a label attached to the input data, i.e., so-called “training data.” That is to say, in this embodiment, the learned model M2 is a model about which machine learning has been done by supervised learning.

The learner 7 has the capability of generating a learned model M2 about the target T1. The learner 7 generates the learned model M2 based on a plurality of labeled learning data (image data). The learned model M2 as used herein may include, for example, either a model that uses a neural network or a model generated by deep learning using a multilayer neural network. Examples of the neural networks may include a convolutional neural network (CNN) and a Bayesian neural network (BNN). The learned model M2 may be implemented by, for example, installing a learned neural network into an integrated circuit such as an application specific integrated circuit (ASIC) or a field-programmable gate array (FPGA). However, the learned model M2 does not have to be such a model generated by deep learning. Alternatively, the learned model M2 may also be a model generated by a support vector machine or a decision tree, for example.

The plurality of pieces of learning data are generated by labeling the plurality of evaluation images B1, which have been created under various painting conditions, as either OK or NG indicating the result of evaluation in accordance with the inspection criteria that has been set up by the criteria setter 14. That is to say, in the example shown in FIG. 4, learning data is generated by labeling the image data of the evaluation images B11-B13 as OK. In addition, learning data is also generated by labeling the image data of the evaluation images B14, B15 as NG. Optionally, learning data may also be generated by labeling the image data of the first standard image A11 as OK. In addition, learning data may be further generated by labeling the image data of the second standard image A12 as NG.

That is to say, it can be said that if the plurality of evaluation images B1 are adopted as the learning data, the labeling work has already been done automatically at a point in time when the inspection criteria are set up. This reduces the chances of causing the user the trouble of newly generating or labeling learning data with respect to the inspection assistance system 1 via a user interface such as the operating interface 3. The learner 7 generates the learned model M2 by making, using a plurality of pieces of labeled learning data, machine learning about good and bad painting conditions of the target T1. The learned model M2 thus generated by the learner 7 is stored in the second storage device 6.

The learner 7 may contribute to improving the performance of the learned model M2 by making re-learning using newly acquired labeled learning data (evaluation images B1). For example, if any evaluation image B1 is created under a new painting condition, then the learner 7 may be made to make re-learning about the new evaluation image B1.

The go/no-go decider 8 makes, using the learned model M2, a go/no-go decision about an inspection image C1 of the target T1. That is to say, the inspection assistance system 1 has the capability of automatically making a go/no-go decision about the painting condition of the target T1 that has gone through a painting process on the actual production line. In the inspection process, the image capture device 2 sequentially captures, one after another, images of the targets T1 that have gone through the painting process and transmits the captured images (inspection images C1) to the server 200. The processor 10 transmits a recognition result of each of the targets T1 to a device being used by the inspector (such as the telecommunications device 9). If the recognition result turns out to be NG (defective), the server 200 sends an alert message to the telecommunications device 9. In addition, the server 200 also transmits a signal to the management equipment that manages the production line to discard any target T1 which has turned out to be NG (defective) (or to stop running the carrier such as a conveyor to allow the inspector to make a visual check of the target T1).

As can be seen from the foregoing description, making machine learning to make a go/no-go decision using the learning data that has been labeled in accordance with the inspection criteria set up by the criteria setter 14 enables making a go/no-go decision more accurately about the surface condition.

Meanwhile, if the manufacturer of the targets T1 is manufacturing the targets T1 at multiple sites (i.e., factories), then the inspection criteria concerning the surface condition inspection may vary from one of those sites to another. That is why information may be shared by, for example, making the server 200 at one site transmit information about the inspection criteria that has been set up by the server 200 to the server 200 at another site over a wide area network such as the Internet. This enables establishing unified inspection criteria for the multiple sites.

### (2.3) Operation

Next, operations (first and second exemplary operations) of the painting management system 100 including the inspection assistance system 1 will be described. Note that in the following description of exemplary operations, the order in which the respective processing steps are performed is only an example and should not be construed as limiting. In addition, in each of the exemplary operations to be described below, some of the processing steps may be omitted as appropriate or an additional processing step may be performed as needed.

### <First Exemplary Operation: Sample Making>

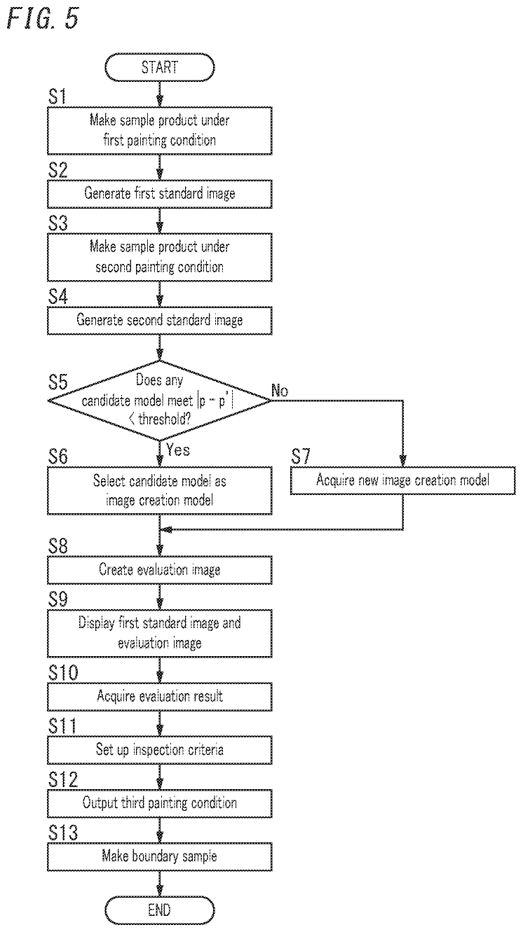

A first exemplary operation including sample making will be described with reference to the flowchart shown in FIG. 5.

First, the maker H1 prepares a standard image A1. Specifically, the painting system 300 performs painting on the target T1 under a first painting condition (including the first standard value P11) to make a real product (sample product) (in Step S1). The image capture device 2 shoots the real product made under the first painting condition (in Step S2: generate first standard image A11). Then, the image capture device 2 transmits the first standard image A11 to the server 200 of the inspection assistance system 1. As a result, the image acquirer 11 of the processor 10 acquires the first standard image A11 about the target T1 for which the first standard value P11 has been set (image acquisition processing).

In addition, the painting system 300 also performs painting on another target T1 (which is provided separately from the target T1 in Step S1) under a second painting condition (including the second standard value P12) to make a real product (in Step S3). The image capture device 2 shoots the real product made under the second painting condition (in Step S4: generate second standard image A12). Then, the image capture device 2 transmits the second standard image A12 to the server 200 of the inspection assistance system 1. As a result, the image acquirer 11 of the processor 10 acquires the second standard image A12 about the target T1 for which the second standard value P12 has been set (image acquisition processing).

The inspection assistance system 1 compares, with a threshold value, the absolute value (|p−p′|) of the difference between the first standard value P11 (painting parameter p) of interest and each of a plurality of first standard values P11 (painting parameters p′) associated with a plurality of candidate models N1. When finding any candidate model N1, of which the absolute value (|p−p′|) is less than the threshold value, in the first storage device 5 (if the answer is YES in Step S5), the inspection assistance system 1 selects the candidate model N1 as the image creation model M1 (in Step S6).

Meanwhile, when finding no candidate models N1, of which the absolute value (|p−p′|) is less than the threshold value (if the answer is NO in Step S5), the inspection assistance system 1 notifies the maker H1 of the result. The maker H1 newly prepares an image creation model M1 and enters its information into the inspection assistance system 1. That is to say, the inspection assistance system 1 acquires the new image creation model M1 (in Step S7).

The inspection assistance system 1 creates a plurality of evaluation images B1 about the target T1 by changing, by reference to the first and second standard values P11, P12, the condition parameter P1 based on the image creation model M1 (in Step S8: image creation processing).

The inspection assistance system 1 makes the display device 4 display the standard image A1 (such as the first standard image A11) and the plurality of evaluation images B1 (in Step S9). The maker compares the standard image A1 displayed with each of the evaluation images B1 displayed, evaluates each of the evaluation images B1 to be either OK or NG, and enters the result of evaluation. That is to say, the inspection assistance system 1 acquires a result of evaluation with respect to each evaluation image B1 (in Step S10).

The inspection assistance system 1 sets up, based on the result of evaluation, inspection criteria concerning the surface condition of the target T1 (in Step S11). The inspection assistance system 1 outputs information about the third painting condition (including the inspection criteria value P13) to the telecommunications device 9 (in Step S12).

The maker H1 prepares a boundary sample in accordance with the information about the third painting condition. That is to say, the painting system 300 performs painting on the target T1 in accordance with the third painting condition to make a boundary sample (in Step S13).

For example, if an auto part manufacturer shares, with customers of auto manufacturers and other people, information about the boundary sample thus made about a painted product (target T1) of a certain part, it makes it easier for the auto part manufacturer to reach an agreement in manufacturing the painted product. In addition, letting the inspector check the boundary sample while the painted product that has gone through the painting process during an actual operation of a production line is being inspected allows the inspection work to be carried out with good stability and accuracy. Even though it could usually take a huge cost and time to make such a boundary sample, this inspection assistance system 1 enables making such a boundary sample efficiently.

### <Second Exemplary Operation: Inspection>

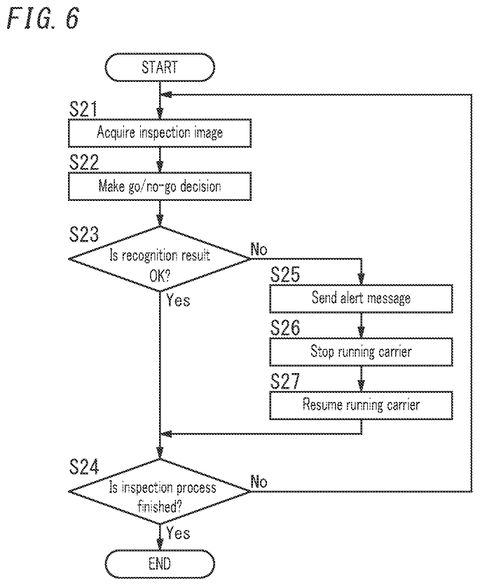

A second exemplary operation including inspection (an inspection process) will be described with reference to the flowchart shown in FIG. 6.

While the production line is up and running, the painting system 300 sequentially performs, in the painting process, painting on targets T1 one after another under a predetermined painting condition (e.g., under the first painting condition) to make painted products (which may be either final products or semi-manufactured products). The image capture device 2 sequentially shoots those painted products that have gone through the painting process (to generate inspection images C1). Then, the image capture device 2 sequentially transmits the inspection images C1 thus shot to the server 200 of the inspection assistance system 1.

The inspection assistance system 1 sequentially acquires the inspection images C1 one after another (in Step S21). Then, the (go/no-go decider 8 of the) inspection assistance system 1 determines, using the learned model M2 and based on the inspection images C1 sequentially acquired, whether the painting condition of each of those targets T1 that have gone through the painting process is good or bad (in Step S22). If the result of recognition is OK (if the answer is YES in Step S23), the inspection assistance system 1 does not send an alert message. If the inspection process is not finished yet (if the answer is NO in Step S24), then the inspection assistance system 1 acquires the next inspection image C1 and makes a go/no-go decision (i.e., the process goes back to Step S21).

On the other hand, if the result of recognition is NG (if the answer is NO in Step S23), then the inspection assistance system 1 sends an alert message to the telecommunications device 9 (in Step S25). In addition, the inspection assistance system 1 also transmits a stop signal to the management equipment to temporarily stop running the carrier that carries the targets T1 (in Step S26). In that case, the inspector heads toward the spot where the inspection process is being carried out, makes a visual check of the real product, and then performs an operation to resume running the carrier (in Step S27). As a result, the inspection process is started over. Alternatively, if the result of recognition is NG, then activating a mechanism for removing the target T1 may replace temporarily stopping running the equipment such as the carrier. When the inspection process is finished (if the answer is YES in Step S24), the process ends.

### <Advantages>

If a surface condition is inspected using appearance feature quantities, there may be a huge amount of data about the appearance feature quantities. For example, in the case of a surface coating layer, there may be multi-dimensional feature quantities if the color (lightness, saturation, and hue), gradation, the degree of granularity, the degree of glitter, the degree of gloss, and the degree of matte are all taken into account. Therefore, it is difficult to express, by a simple feature quantity, a sense of texture that an object gives to a human viewer. Also, even if the sense of texture could be expressed by a feature quantity, the subjective evaluation should go through a huge number of trials.

In contrast, in the inspection assistance system 1 according to this embodiment, a plurality of evaluation images B1 are created by using a condition parameter P1 which is set as a part of a process condition. Thus, using the evaluation images B1 makes it easier to set up inspection criteria than making design about complicated appearance feature quantities. This is because using the evaluation images B1 means using parameters of a lower order (such as the discharge rate or the number of times of overcoating). Consequently, this inspection assistance system 1 achieves the advantage of reducing the need for complicated design.

In addition, according to this embodiment, a display device 4 that displays the standard image A1 and the evaluation images B1 is provided, thus allowing the user to make a visual check of the standard image A1 and the evaluation images B1. This makes it easier for him or her to set up the inspection criteria.

Furthermore, according to this embodiment, the standard image A1 is a captured image generated by making the image capture device 2 shoot the target T1. This enables preparing the standard image A1 more easily, and setting up the inspection criteria more accurately, than in a situation where the standard image A1 is a CG image, for example.

In particular, according to this embodiment, the image creator 12 creates the evaluation images B1 by changing the condition parameter P1 between the first standard value P11 and the second standard value P12. This allows a directivity about a change in the painting condition of the target T1 to be defined more definitely. That is to say, it makes it easier to quantify a specific direction in which the color density of the paint (i.e., surface coating layer) is going to change, thus enabling making a linear approximation of the variation characteristic of the surface condition (painting condition) with respect to the condition parameter P1.

### (3) Variations

Note that the embodiment described above is only an exemplary one of various embodiments of the present disclosure and should not be construed as limiting. Rather, the exemplary embodiment may be readily modified in various manners depending on a design choice or any other factor without departing from the scope of the present disclosure. The functions of the inspection assistance system 1 according to the exemplary embodiment described above may also be implemented as an inspection assistance method, a computer program, or a non-transitory storage medium on which the computer program is stored.

Next, variations of the exemplary embodiment will be enumerated one after another. Note that the variations to be described below may be adopted in combination as appropriate. In the following description, the exemplary embodiment described above will be hereinafter sometimes referred to as a “basic example.”

The inspection assistance system 1 according to the present disclosure includes a computer system. The computer system may include a processor and a memory as principal hardware components thereof. The functions of the inspection assistance system 1 according to the present disclosure may be performed by making the processor execute a program stored in the memory of the computer system. The program may be stored in advance in the memory of the computer system. Alternatively, the program may also be downloaded through a telecommunications line or be distributed after having been recorded in some non-transitory storage medium such as a memory card, an optical disc, or a hard disk drive, any of which is readable for the computer system. The processor of the computer system may be made up of a single or a plurality of electronic circuits including a semiconductor integrated circuit (IC) or a large-scale integrated circuit (LSI). As used herein, the “integrated circuit” such as an IC or an LSI is called by a different name depending on the degree of integration thereof. Examples of the integrated circuits include a system LSI, a very-large-scale integrated circuit (VLSI), and an ultra-large-scale integrated circuit (ULSI). Optionally, a field-programmable gate array (FPGA) to be programmed after an LSI has been fabricated or a reconfigurable logic device allowing the connections or circuit sections inside of an LSI to be reconfigured may also be adopted as the processor. Those electronic circuits may be either integrated together on a single chip or distributed on multiple chips, whichever is appropriate. Those multiple chips may be aggregated together in a single device or distributed in multiple devices without limitation. As used herein, the “computer system” includes a microcontroller including one or more processors and one or more memories. Thus, the microcontroller may also be implemented as a single or a plurality of electronic circuits including a semiconductor integrated circuit or a large-scale integrated circuit.

Also, a configuration in which the plurality of functions of the inspection assistance system 1 are aggregated together in a single housing is not an essential configuration for the inspection assistance system 1. Alternatively, respective constituent elements of the inspection assistance system 1 may also be distributed separately in multiple different housings, for example.

Conversely, the plurality of functions of the inspection assistance system 1 may be aggregated together in a single housing. Optionally, at least some functions of the inspection assistance system 1 (e.g., some functions of the inspection assistance system 1) may be implemented as a cloud computing system.

### (3.1) First Variation

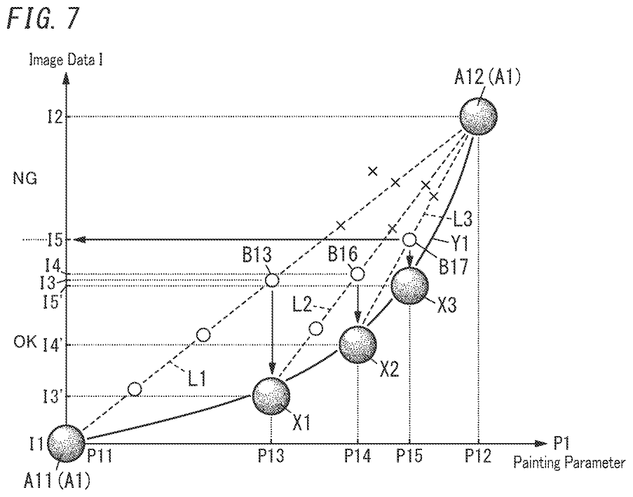

Next, an inspection assistance system 1 according to a first variation will be described with reference to FIG. 7. In the following description, any constituent element of this first variation, having substantially the same function as a counterpart of the basic example described above, will be designated by the same reference numeral as that counterpart's, and description thereof will be omitted herein as appropriate.

In the basic example described above, the image creator 12 creates a plurality of evaluation images B1 by changing the condition parameter P1 on the premise that the RGB color density varies linearly with respect to the condition parameter P1. Actually, however, as the condition parameter P1 increases, the color density may not vary (increase) linearly but may gradually increase curvilinearly, for example, in some cases.

In FIG. 7, the dotted line L1 is the same as the variation characteristics of the basic example shown in FIGS. 3 and 4. As in the basic example, the inspection assistance system 1 is supposed to determine the image data 13 (color density) and the inspection criteria value P13 (third painting condition) of the evaluation image B13 (refer to FIGS. 3 and 4) to be the inspection criteria. In this case, if the target T1 (boundary sample) has been made by making the painting system 300 perform painting in accordance with the third painting condition, the captured image X1 (refer to FIG. 7), generated by making the image capture device 2 shoot the boundary sample, may have caused a shift in color density compared to the evaluation image B13 created by the image creator 12. Specifically, in the example shown in FIG. 7, the color density of the captured image X1 is lower than that of the evaluation image B13.

In summary, as indicated by the solid curve Y1 shown in FIG. 7, the “true variation characteristic” in response to a change in painting condition may have some “error” (i.e., may have shifted) with respect to the ideal line (the dotted line L1). Nevertheless, the solid curve Y1 representing the “true variation characteristic” may be actually unknown and may be difficult to obtain by calculations, for example.

Thus, according to this variation, until this “error” is eliminated (e.g., to a predetermined value or less), a series of processing steps, including setting a standard value, creating and displaying the evaluation images B1, acquiring the results of evaluation from the maker H1, and setting up the inspection criteria based on the results of evaluation, are repeatedly performed, which is a difference from the basic example described above. This series of processing steps will be hereinafter referred to as a “criteria setting process.”

First, in performing the criteria setting process for the first time, the processor 10 compares the difference in color density between the evaluation image B13 and a captured image X1 as its (provisional) boundary sample (i.e., the difference between the image data 13 and image data I3′) with a predetermined value.

In the example shown in FIG. 7, the difference is equal to or greater than the predetermined value. This means that the “error” has not been eliminated yet through the first criteria setting process. Thus, the inspection assistance system 1 according to this variation performs the criteria setting process for the second time. When performing the criteria setting process for the second time, the processor 10 sets the inspection criteria value P13 in accordance with the third painting condition as a new standard value. That is to say, the image creator 12 sets the captured image X1 at the origin (i.e., as the first standard image A11). The condition determiner 16 determines the degree of similarity with respect to the new standard value (i.e., the inspection criteria value P13). If the plurality of candidate models N1 includes any candidate model N1 associated with a standard value, which has a high degree of similarity to the new standard value, the condition determiner 16 selects the candidate model N1 as the image creation model M1 for use in the second criteria setting process. On the other hand, if there are no such candidate models N1 with a high degree of similarity, the maker H1 prepares a new image creation model M1 and registers the image creation model M1 with the inspection assistance system 1.

The image creator 12 creates a plurality of evaluation images B1 again using the image creation model M1 applied to the second criteria setting process. In FIG. 7, the dotted line L2 indicates a variation characteristic in color density with respect to the condition parameter P1 according to the newly applied image creation model M1. The inspection assistance system 1 makes the display device 4 display again the plurality of evaluation images B1 thus created and sets up the inspection criteria in accordance with the results of evaluation by the maker H1. Suppose the inspection assistance system 1 has determined the inspection criteria value P14 (fourth painting condition) of the evaluation image B16 (refer to FIG. 7) to be the inspection criteria. Then, the painting system 300 performs painting in accordance with the fourth painting condition to make the target T1 (boundary sample) and a captured image X2 (refer to FIG. 7) is generated by shooting the boundary sample. In performing the criteria setting process for the second time, the processor 10 compares the difference in color density between the evaluation image B16 and a captured image X2 as its (provisional) boundary sample (i.e., the difference between the image data 14 and image data 14′) with a predetermined value.

In the example shown in FIG. 7, the difference is equal to or greater than the predetermined value. This means that the “error” has not been eliminated yet even through the second criteria setting process. Thus, the inspection assistance system 1 performs the criteria setting process for the third time. When performing the criteria setting process for the third time, the processor 10 sets the inspection criteria value P14 in accordance with the fourth painting condition as a new standard value. That is to say, the image creator 12 sets the captured image X2 at the origin (i.e., as the first standard image A11). The condition determiner 16 determines the degree of similarity with respect to the new standard value (i.e., the inspection criteria value P14). If the plurality of candidate models N1 includes any candidate model N1 associated with a standard value, which has a high degree of similarity to the new standard value, the condition determiner 16 selects the candidate model N1 as the image creation model M1 for use in the third criteria setting process. On the other hand, if the plurality of candidate models N1 includes no such candidate models N1 with a high degree of similarity, the maker H1 makes a new image creation model M1 and registers the image creation model M1 with the inspection assistance system 1.

The image creator 12 creates a plurality of evaluation images B1 again using the image creation model M1 applied to the third criteria setting process. In FIG. 7, the dotted line L3 represents a variation characteristic in color density with respect to the condition parameter P1 according to the newly applied image creation model M1. The inspection assistance system 1 makes the display device 4 display again the plurality of evaluation images B1 thus created and sets up the inspection criteria in accordance with the results of evaluation by the maker H1. Suppose the inspection assistance system 1 has determined the inspection criteria value P15 (fifth painting condition) of the evaluation image B17 (refer to FIG. 7) to be the inspection criteria. Then, the painting system 300 performs painting in accordance with the fifth painting condition to make the target T1 (boundary sample) and a captured image X3 (refer to FIG. 7) is generated by shooting the boundary sample. In performing the criteria setting process for the third time, the processor 10 compares the difference in color density between the evaluation image B17 and a captured image X3 as its (provisional) boundary sample (i.e., the difference between the image data I5 and image data I5′) with a predetermined value.

In the example shown in FIG. 7, the difference is less than the predetermined value, and therefore, a decision is made that the “error” have been eliminated through the third criteria setting process. Then, in the third criteria setting process, the inspection assistance system 1 determines the inspection criteria value P15 (fifth painting condition) to be a true inspection criterion. In that case, a product painted in accordance with the fifth painting condition will be used as a true boundary sample.

In the example described above, the inspection assistance system 1 automatically determines, by comparing the difference with the predetermined value, whether the “error” has been eliminated. Alternatively, the decision may also be made by making the maker H1 make a visual check.

The configuration according to this variation further improves the accuracy of the inspection criteria. In addition, this allows an (unknown) solid curve Y1, representing the “true variation characteristic,” to be located based on the locus of the captured images X1, X2, X3, and so on. This enables creating an image creation model M1 which is even closer to the real object.

### (3.2) Second Variation

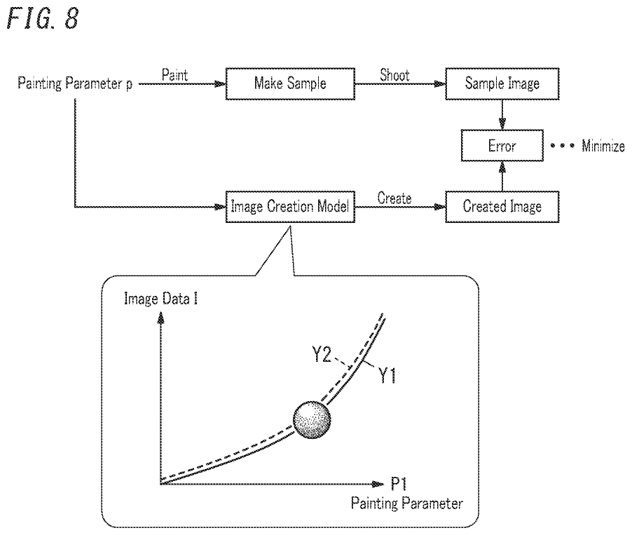

Next, an inspection assistance system 1 according to a second variation will be described with reference to FIG. 8. In the following description, any constituent element of this second variation, having substantially the same function as a counterpart of the basic example described above, will be designated by the same reference numeral as that counterpart's, and description thereof will be omitted herein as appropriate.

In the basic example described above, the image creation model M1 is a function model that uses the condition parameter P1 as a variable. According to this variation, the image creation model M1 is a model defined by making machine learning (i.e., a learned model) with respect to an image that has been generated with the condition parameter P1 changed, which is a difference from the basic example described above.

For example, in the first variation described above, the criteria setting process is performed repeatedly to eliminate the “error” (i.e., to locate an (unknown) solid curve Y1. The image creation model M1 may also be machine-learned to minimize this “error.” Specifically, a neural network for predicting the surface condition may be established and used as the image creation model M1. Then, the neural network is made to learn and optimized to minimize the error between an image created by the image creation model M1 and a sample image generated by shooting an actually painted sample product. Optionally, the neural network may also be implemented as a generative adversarial network (GAN) in which two networks, namely, a generator and a discriminator, are made to learn while competing with each other.

In that case, the captured images X1, X2, X3, and so on, for example, may be used as the training data. Applying the machine-learned image creation model M1 as is done in this variation may bring the variation characteristic (represented by the dotted curve Y2) even closer to the solid curve Y1 as shown in FIG. 8.

### (3.3) Third Variation

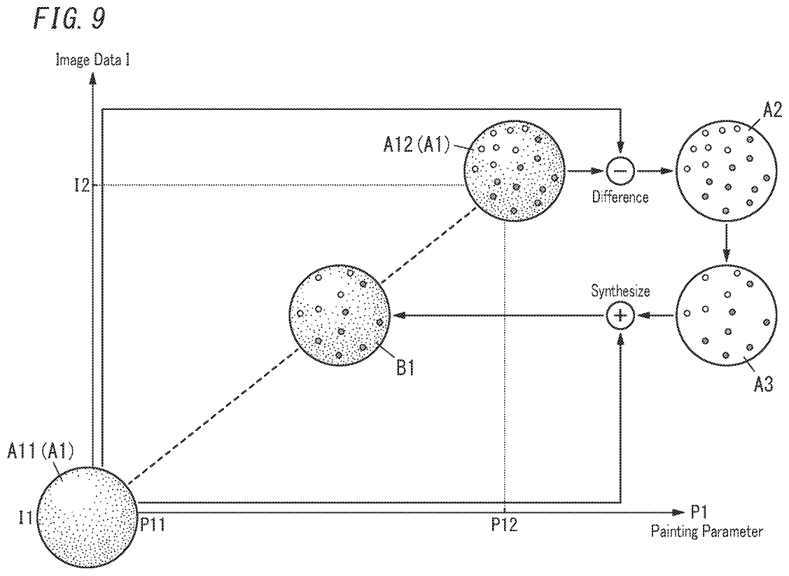

Next, an inspection assistance system 1 according to a third variation will be described with reference to FIG. 9. In the following description, any constituent element of this third variation, having substantially the same function as a counterpart of the basic example described above, will be designated by the same reference numeral as that counterpart's, and description thereof will be omitted herein as appropriate.

In the basic example described above, the image data I represents a variation in RGB color density. In this variation, the image data I represents a variation in texture ratio, which is a difference from the basic example described above. In FIG. 9, as an exemplary texture ratio, a granular ratio indicating the degree of granularity, which increases by using a paint containing a flitter such as pieces of metal in surface painting to present a unique sense of texture, is shown as an example. Specifically, the first standard image A11 has a granular ratio β of zero. In the second standard image A12, a certain number of grains are present within a predetermined region. The granular ratio β is a value obtained by normalizing the painting parameter p and may have a value falling within the range from 0 to 1. That is to say, the granular ratio β scales possible values for a pair of standard images (i.e., from the first standard image A11 through the second standard image A12) to the range from 0 through 1 with respect to the painting parameters p such as the discharge rate, the number of times of overcoating, and the atomization pressure.

In this variation, the processor 10 of the inspection assistance system 1 extracts, through image processing, only a granular texture from the second standard image A12 (refer to the texture A2 shown in FIG. 9). The processor 10 defines the granular ratio β of the texture A2 to be 1.

According to this variation, the image creator 12 makes the granular ratio β (condition parameter P1) vary within the range from 0 to 1 based on the image creation model M1. The image creator 12 creates the evaluation image B1 by adding (synthesizing) a granular texture A3 corresponding to the granular ratio β (of 0.5, for example) to the first standard image A11. In this case, the image creation model M1 is a model used to quantify the direction of shift of the (granular) texture.

According to the configuration of this variation, the evaluation image B1 may also be created with respect to the variation in (granular) texture as well.

### (3.4) Other Variations

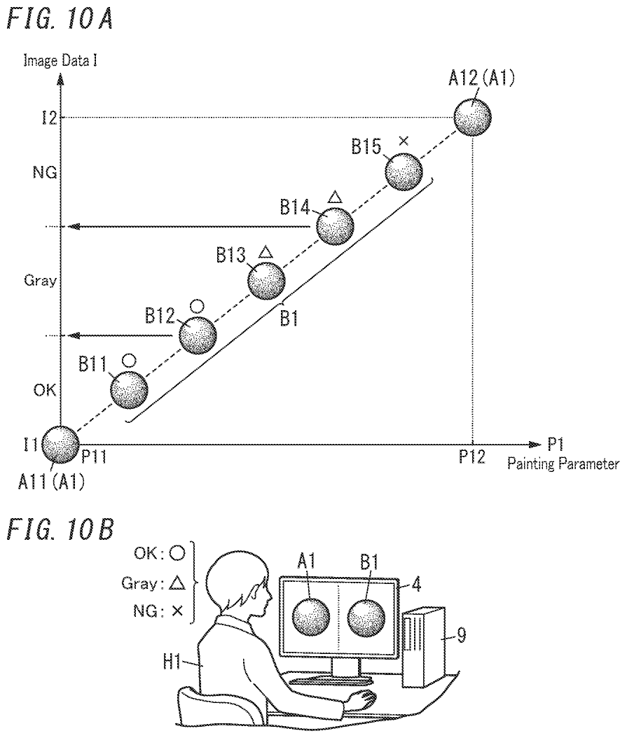

In the basic example described above, the result of evaluation is expressed in either of two stages, namely, either GO (OK) or NO-GO (NG). However, the result of evaluation may also be expressed in any one of three or more stages. For example, the result of evaluation may also be expressed in any one of three stages, namely, GO (OK), NO-GO (NG), and a gray area as an intermediate stage between GO and NO-GO as shown in FIG. 10A. The maker H1 evaluates each evaluation image B1 with the eye and uses the operating interface 3 to enter a result of evaluation (which is any one of OK, NG, or gray area) with respect to each evaluation image B1 as shown in FIG. 10B. Specifically, in the example shown in FIG. 10A, the results of evaluations with respect to the evaluation images B13, B14 are both gray area and an open triangle mark is placed beside each of these evaluation images B13, B14. In this case, a boundary sample may be made in accordance with a painting condition associated with at least one of the evaluation images B12-B14 (e.g., the evaluation images B12 and B14). As can be seen, providing such a gray area as an intermediate stage between OK and NG enabling setting the inspection criteria more finely (i.e., in a larger number of stages). Optionally, in that case, a good product boundary sample indicating an OK limit may be made in accordance with the painting condition associated with the evaluation image B12 which is evaluated to be OK, but which is closest to the evaluation image B13 evaluated to be the gray area. Also, a defective product boundary sample indicating an NG limit may be made in accordance with the painting condition associated with the evaluation image B15 which is evaluated to be NG, but which is closest to the evaluation image B14 evaluated to be the gray area.

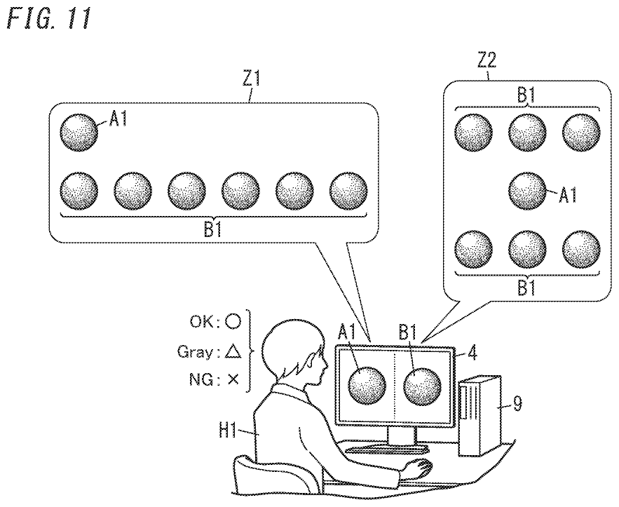

In the basic example described above, the display device 4 simultaneously displays the standard image A1 and each evaluation image B1 one to one on the same screen. However, this is not the only mode of display. Alternatively, the display device 4 may also display the standard image A1 and all evaluation images B1 simultaneously on the same screen, as in the screen Z1 shown in FIG. 11, with all the evaluation images B1 arranged side by side in line. That is to say, the display device 4 may display the evaluation images B1 as a list. Still alternatively, the display device 4 may also display the standard image A1 and all evaluation images B1 simultaneously on the same screen, as in the screen Z2 shown in FIG. 11, with all the evaluation images B1 surrounding the standard image A1 that is disposed at the center. This allows the maker H1 to reduce the number of times of trials, compared to the basic example in which the maker H1 is required to compare the standard image A1 with the evaluation image B1 one by one.

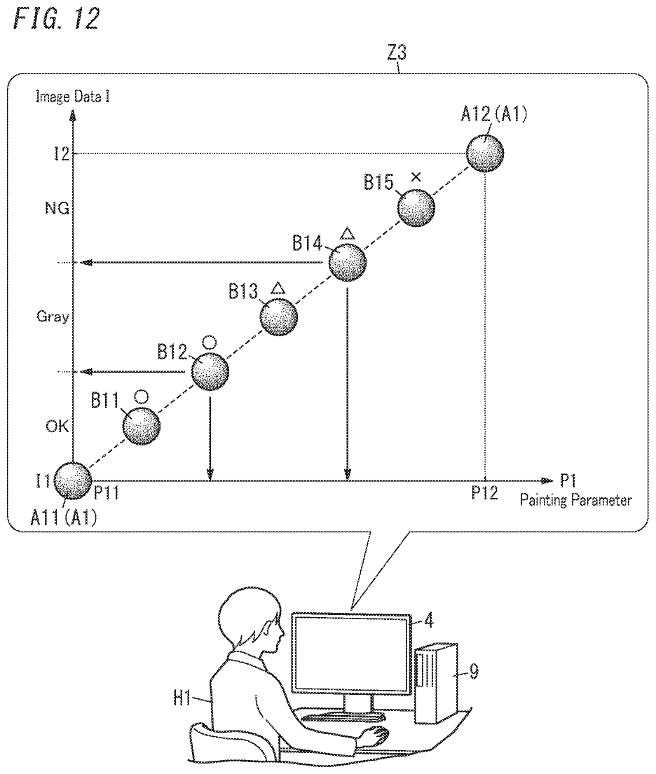

Furthermore, besides displaying the standard image A1 and the evaluation image(s) B1 on the screen, the display device 4 may also display, on the screen, the process through which the inspection criteria is set up and the result as in the screen Z3 shown in FIG. 12. In the example shown in FIG. 12, a graph including the results about the inspection criteria shown in FIG. 10A is displayed on the screen Z3. This allows the maker H1 to easily recognize the process through which the inspection criteria have been set up.

In the basic example described above, the inspection assistance system 1 creates the evaluation images B1 by changing the condition parameter P1 in an increasing direction from the origin (first standard value P11). However, this is only an example and should not be construed as limiting. Alternatively, the inspection assistance system 1 may also create the evaluation images B1 by changing the condition parameter P1 in a decreasing direction from either the first standard value P11 or the second standard value P12, for example.

### (4) Recapitulation

As can be seen from the foregoing description, an inspection assistance system (1) according to a first aspect includes an image acquirer (11) and an image creator (12). The image acquirer (11) acquires a standard image (A1) about a target (T1). The standard image (A1) is associated with a condition parameter (P1) set at a standard value. The condition parameter (P1) is set as a part of a process condition concerning a surface condition of the target (T1). The image creator (12) creates, by reference to the standard value, a plurality of evaluation images (B1) about the target (T1) by changing the condition parameter (P1) based on a predetermined image creation model (M1) and the standard image (A1).

According to this aspect, a plurality of evaluation images (B1) are created by using a condition parameter (P1) to be set as a part of a process condition. Thus, using the evaluation images (B1) makes it easier to set up inspection criteria than making a design about complicated appearance feature quantities, for example. Consequently, this inspection assistance system (1) achieves the advantage of reducing the need for complicated design.

An inspection assistance system (1) according to a second aspect, which may be implemented in conjunction with the first aspect, further includes a display device (4) that displays the standard image (A1) and the plurality of evaluation images (B1).

This aspect allows the user to make a visual check of the standard image (A1) and the plurality of evaluation images (B1), thus making it easier to set up the inspection criteria.

An inspection assistance system (1) according to a third aspect, which may be implemented in conjunction with the first or second aspect, further includes an evaluation acquirer (13) and a criteria setter (14). The evaluation acquirer (13) acquires evaluation information about results of evaluation made in two or more stages for the plurality of evaluation images (B1). The criteria setter (14) sets up, in accordance with the evaluation information, inspection criteria concerning the surface condition of the target (T1).

This aspect allows inspection criteria to be set up more accurately.

An inspection assistance system (1) according to a fourth aspect, which may be implemented in conjunction with the third aspect, further includes an outputter (15) that outputs information about the condition parameter (P1) associated with the inspection criteria.

This aspect allows a real product (i.e., a boundary sample) that meets the inspection criteria to be made and checked by feeding back the information thus output to a process concerning the surface condition, for example.

An inspection assistance system (1) according to a fifth aspect, which may be implemented in conjunction with the third or fourth aspect, further includes a learner (7) and a go/no-go decider (8). The learner (7) generates a learned model (M2) by using, as learning data, image data, to which a label is attached. The label is based on the inspection criteria set up by the criteria setter (14) and indicating whether the surface condition is good or bad. The go/no-go decider (8) makes, using the learned model (M2), a go/no-go decision about an inspection image (C1) of the target (T1).

This aspect allows a go/no-go decision about the surface condition to be made more accurately.

An inspection assistance system (1) according to a sixth aspect, which may be implemented in conjunction with any one of the first to fifth aspects, further includes a storage device (first storage device 5) and a condition determiner (16). The storage device (first storage device 5) stores a plurality of candidate models (N1) respectively associated with a plurality of standard values of the condition parameter (P1). The condition determiner (16) determines a degree of similarity between the standard value of the standard image (A1) and each of the plurality of standard values and selects, when the plurality of standard values includes any particular value having a high degree of similarity with the standard value, a candidate model (N1), associated with the particular value and belonging to the plurality of candidate models (N1), as the image creation model (M1).

This aspect saves the trouble of newly making or selecting an image creation model (M1).

In an inspection assistance system (1) according to a seventh aspect, which may be implemented in conjunction with any one of the first to sixth aspects, the standard image (A1) is a captured image generated by making an image capture device (2) shoot the target (T1).

This aspect allows the standard image (A1) to be prepared more easily than in a situation where the standard image (A1) is a CG image, for example. In addition, this aspect also allows inspection criteria to be set up more accurately.

In an inspection assistance system (1) according to an eighth aspect, which may be implemented in conjunction with any one of the first to seventh aspects, the image acquirer (11) further acquires the standard image (A1) associated with the condition parameter (P1) set at a second standard value (P12). The second standard value (P12) is different from a first standard value (P11) as the standard value. The image creator (12) creates the plurality of evaluation images (B1) by changing the condition parameter (P1) between the first standard value (P11) and the second standard value (P12).

This aspect allows a directivity about a change in the surface condition of the target (T1) to be defined more definitely.

In an inspection assistance system (1) according to a ninth aspect, which may be implemented in conjunction with any one of the first to eighth aspects, the image creation model (M1) is a function model that uses the condition parameter (P1) as a variable.

This aspect allows the image creation model (M1) to be prepared more easily, and reduces the need for complicated design, compared to a situation where the image creation model (M1) is a machine learned model, for example.

In an inspection assistance system (1) according to a tenth aspect, which may be implemented in conjunction with any one of the first to eighth aspects, the image creation model (M1) is obtained by making machine learning about an image created with the condition parameter (P1) changed.

This aspect improves the accuracy about the image creation model (M1) to the point of more easily creating an evaluation image (B1) even closer to a real object.

In an inspection assistance system (1) according to an eleventh aspect, which may be implemented in conjunction with any one of the first to tenth aspects, the process condition is a painting condition. The condition parameter (P1) is at least one parameter selected from the group consisting of: a discharge rate of a paint: an atomization pressure of the paint: a spraying distance to a surface of the target (T1); a number of times of overcoating: and a drying rate of the paint.

This aspect reduces the need for complicated design about painting.

An inspection assistance method according to a twelfth aspect includes image acquisition processing and image creation processing. The image acquisition processing includes acquiring a standard image (A1) about a target (T1). The standard image (A1) is associated with a condition parameter (P1) set at a standard value. The condition parameter (P1) is set as a part of a process condition concerning a surface condition of the target (T1). The image creation processing includes creating, by reference to the standard value, a plurality of evaluation images (B1) about the target (T1) by changing the condition parameter (P1) based on a predetermined image creation model (M1) and the standard image (A1).

This aspect provides an inspection assistance method that reduces the need for complicated design.

A program according to a thirteenth aspect is designed to cause one or more processors to perform the inspection assistance method according to the twelfth aspect.

This aspect provides a function that reduces the need for complicated design.

Note that the constituent elements according to the second to eleventh aspects are not essential constituent elements for the inspection assistance system (1) but may be omitted as appropriate.

### REFERENCE SIGNS LIST

1 Inspection Assistance System
11 Image Acquirer
12 Image Creator
13 Evaluation Acquirer
14 Criterion Setter
15 Outputter
16 Condition Determiner
2 Image Capture Device
4 Display Device
5 First Storage Device (Storage Device)
7 Learner
8 Go/No-Go Decider
A1 Standard Image
B1 Evaluation Image
C1 Inspection Image
M1 Image Generation Model
M2 Learned Model
N1 Candidate Model
P1 Condition Parameter
P11 First Standard Value
P12 Second Standard Value
T1 Target

1. An inspection assistance system comprising:
an image acquirer configured to acquire a standard image about a target, the standard image being associated with a condition parameter set at a standard value, the condition parameter being set as a part of a process condition concerning a surface condition of the target; and
an image creator configured to create, by reference to the standard value, a plurality of evaluation images about the target by changing the condition parameter based on a predetermined image creation model and the standard image.

2. The inspection assistance system of claim 1, further comprising a display device configured to display the standard image and the plurality of evaluation images.

3. The inspection assistance system of claim 1, further comprising:
an evaluation acquirer configured to acquire evaluation information about results of evaluation made in two or more stages for the plurality of evaluation images; and
a criteria setter configured to set up, in accordance with the evaluation information, inspection criteria concerning the surface condition of the target.

4. The inspection assistance system of claim 3, further comprising an outputter configured to output information about the condition parameter associated with the inspection criteria.

5. The inspection assistance system of claim 3, further comprising:
a learner configured to generate a learned model by using, as learning data, image data, to which a label is attached, the label being based on the inspection criteria set up by the criteria setter and indicating whether the surface condition is good or bad; and
a go/no-go decider configured to make, using the learned model, a go/no-go decision about an inspection image of the target.

6. The inspection assistance system of claim 1, further comprising:
a storage device configured to store a plurality of candidate models respectively associated with a plurality of standard values of the condition parameter; and
a condition determiner configured to determine a degree of similarity between the standard value of the standard image and each of the plurality of standard values and select, when the plurality of standard values includes any particular value having a high degree of similarity with the standard value, a candidate model, associated with the particular value and belonging to the plurality of candidate models, as the image creation model.

7. The inspection assistance system of claim 1, wherein
the standard image is a captured image generated by making an image capture device shoot the target.

8. The inspection assistance system of claim 1, wherein
the image acquirer is configured to further acquire the standard image associated with the condition parameter set at a second standard value, the second standard value being different from a first standard value as the standard value, and
the image creator is configured to create the plurality of evaluation images by changing the condition parameter between the first standard value and the second standard value.

9. The inspection assistance system of claim 1, wherein
the image creation model is a function model that uses the condition parameter as a variable.

10. The inspection assistance system of claim 1, wherein
the image creation model is obtained by making machine learning about an image created with the condition parameter changed.

11. The inspection assistance system of claim 1, wherein
the process condition is a painting condition, and
the condition parameter is at least one parameter selected from the group consisting of: a discharge rate of a paint; an atomization pressure of the paint; a spraying distance to a surface of the target; a number of times of overcoating; and a drying rate of the paint.

12. An inspection assistance method comprising:
image acquisition processing including acquiring a standard image about a target, the standard image being associated with a condition parameter set at a standard value, the condition parameter being set as a part of a process condition concerning a surface condition of the target; and
image creation processing including creating, by reference to the standard value, a plurality of evaluation images about the target by changing the condition parameter based on a predetermined image creation model and the standard image.

13. A non-transitory computer-readable tangible recording medium storing a program designed to cause one or more processors to perform the inspection assistance method of claim 12.
